(19) United States
(12) Patent Application Publication
(10) Pub. No.: US 2016/0284317 A1
(43) Pub. Date: Sep. 29, 2016

(54) METHOD, DEVICE AND SYSTEM FOR LOADING AND DISPLAYING PICTURES

(71) Applicant: XINYU XINGBANG INFORMATION INDUSTRY CO., LTD., Xinyu City (CN)

(72) Inventors: Xiaohong YAO, Xinyu City (CN); Zhihong ZHOU, Xinyu City (CN)

(21) Appl. No.: 15/008,952

(22) Filed: Jan. 28, 2016

(30) Foreign Application Priority Data
Mar. 24, 2015 (CN) 201510130161.7

(51) Int. Cl. G09G 5/14; G06T 11/60; G06T 13/80

(52) U.S. Cl. CPC G09G 5/14; G06T 13/80; G06T 11/60; G09G 2340/04; G09G 2340/0464; G09G 2350/00; G09G 2310/02

(57) ABSTRACT

Disclosed is a method of loading and displaying pictures which comprises using a processor to load a first link address of a picture; determining by the processor on whether a number of bytes of the picture exceeds a threshold according to metadata of the picture parsed from the first link address of the picture, loading the picture directly by the processor if the number of bytes does not exceed the threshold, otherwise dividing the picture into a plurality of sub-pictures according to a partition rule of, adding the partition rule into metadata of the original picture to generate a second link address of the picture, and assembling picture data of the plurality of sub-pictures to restore the picture in accordance with the partition rule contained in the metadata. Pictures are loaded in an animation form, which reduces burdens of a server, and improves users' experience.

### FIELD OF THE INVENTION

The present invention relates to computer network communications, particularly to a method, device and system for loading and displaying a picture, especially for loading and displaying an oversized picture.

### BACKGROUND OF THE INVENTION

Conventionally, a large picture is usually loaded after whole data of the picture is downloaded, which makes user to wait for a while and degrades the user's experience. Another way is to process a large picture to generate some low resolution images for a preview, and replace these low resolution images with the complete picture downloaded. Although this can solve the problem of a long wait to improve user's experience, it is necessary for the server to generate a variety of pictures with different resolutions, which increases the computing and storage burden of the server. At the same time, a plurality of image addresses should be provided for switching multiple pictures, and repeated verification between the server and a client end should be performed, thus increasing the complexity and processing load for loading large pictures.

### SUMMARY OF THE INVENTION

In view of the defects of the prior art discussed above, an object of the present application is to provide a method for loading and displaying pictures. The method which can be performed by a computing system having a processor and a memory, the method comprises loading, at a server computer, a first link address of a picture to be uploaded; determining, at the server computer, on whether a number of bytes of the picture exceeds a threshold according to metadata of the picture parsed from the first link address of the picture, and dividing, at the server computer, the picture into a plurality of sub-pictures according to a partition rule, if the number of bytes of the picture exceeds the threshold, incorporating the partition rule into metadata of the original picture (i.e., before divided) to generate a second link address of the picture, and assembling, at a client end computer, picture data of the plurality of sub-pictures to restore the picture in accordance with the partition rule contained in the metadata which is parsed out by the processor of the client end loading the second link address.

Accordingly, a large picture is divided into a plurality of sub-pictures at a server end and the original picture will be restored at a device (client end) by loading the second link address of the original picture rather than loading the address of each divided sub-picture and by individually loading each high-resolution sub-picture according to a partition rule, which can reduce the computing and storage burden of the server and provide an uploaded picture with high resolution, thus improving user's experience.

In addition, the application discloses a device for loading and displaying pictures, wherein the device includes a processor and a memory. The device comprises a loading means implemented by the processor and configured to load a first link address of a picture; a determining means implemented by the processor and configured to judge whether a number of bytes of the original picture exceeds a threshold according to metadata of the picture parsed out by the first link address of the picture; and a restoring means implemented by the processor and configured to load a second link address of the picture which has been divided into a plurality of sub-pictures according to a partition rule if the number of bytes of the picture exceeds the threshold, parse a partition rule incorporated in the metadata through the second link address, and assemble data of the plurality of sub-pictures in accordance with the partition rule to restore the picture.

The first link address may be a uniform resource locator (URL) address of the picture generated by a combining coding of the metadata of the picture comprising at least one of number of bytes, resolution, animation type, creation time, clipping coefficient and picture address.

In addition, the present application provides a system for loading and displaying pictures which comprises a server comprising a processor and a memory, the processor executes instructions stored in the memory to judge whether a number of bytes of a picture exceeds a threshold set by the server according to metadata of the picture parsed out according to a first link address, and divide the picture into a plurality of sub-pictures according to a partition rule, if the number of bytes exceeds the threshold set by the server, and then add the partition rule into the metadata of the original picture to generate a second link address of the picture; a client end having a processor and a memory, the processor executes instructions stored in the memory to load the first link address of the picture directly and display the picture when it is judged that the number of bytes of the picture does not exceed the threshold set by the server, and load the second link address, if it is judged that the number of bytes of the picture exceeds the threshold, and restore and display the original picture based on the metadata parsed out through the second link address.

The first link address may be a uniform resource locator (URL) address of the picture generated by a combining coding of the metadata of the picture comprising at least one of number of bytes, resolution, animation type, creation time, clipping coefficient and picture address.

Specifically, partitioned picture data of large pictures are stored on a remote network server, and a single “link to load” of pictures (the link to load has been generated by calculation when the picture is uploaded) is provided. When a client end loads a picture, the link address of this picture will be loaded. The metadata of the picture will be parsed out by an address interceptor on the server for processing according to the link address. If the size of the picture recorded in the metadata exceeds a “threshold” set by the server, then all partitioned picture data of the picture will be assembled in order in accordance with the partition rule incorporated in the metadata, and partitions are made among the sub-pictures with special division symbols. The device-side loads a link address of the original picture (i.e., picture before divided) receives socket contents of the address, and then parses the received contents to restore the partitioned picture data of the picture and finally loads these partitioned picture data in order. In such a manner of picture loading, a loading effect in an animation form can be realized at the client end.

In addition, the present application further provides a computer-readable storage device carrying instructions for performing a method of loading and displaying picture, the device comprises loading a first link address of a picture to be uploaded, determining on whether a number of bytes of the picture exceeds a threshold according to metadata of the picture parsed from the first link address of the picture, dividing the picture of which the number of bytes exceeds the threshold into a plurality of sub-pictures according to a partition rule, incorporating the partition rule into metadata of the original picture to generate a second link address of the picture, and assembling picture data of the plurality of sub-pictures to restore the picture in accordance with the partition rule incorporated in the metadata which is parsed out by the processor of the client end loading the second link address.

The method, device and system for loading and displaying pictures presented in the present application have a substantial effect for large pictures. There is no need to store a plurality piece of pictures at the device-side when loading the picture. Restoring an original large picture can be carried out by loading the second link address of the original picture at the device-side rather than loading the address of each divided sub-picture and by individually loading high-resolution sub-pictures one-by-one according to a partition rule, which can reduce computing and storage burden of the server while providing an uploaded picture with high resolution and a better experience to users.

### BRIEF DESCRIPTION OF THE DRAWINGS

FIG. 1 is a schematic diagram of a process for loading a picture according to an embodiment of the present invention;

FIG. 2 schematically shows partition rule for a large picture according to an embodiment of the present invention;

FIG. 3 is a flow diagram showing a process of loading partitioned data at a client end according to an embodiment of the present invention;

FIG. 4 schematically shows obtaining partitioned data and producing animation effect at a client end according to an embodiment of the present invention;

FIG. 5 schematically shows a generation of picture link addresses according to an embodiment of the present invention; and

FIG. 6 is a block diagram schematically showing a system for loading and displaying pictures according to an embodiment of the present invention.

### DETAILED DESCRIPTION

A computer system for implementing a process of loading partitioned data at a client end according to the present invention may be implemented via personal computers, mobile devices, tablet computers, televisions, appliances, and the like. The picture can be presented by web pages, an Intelligent Agent user interface, mobile applications (including third party apps), and the like. Accordingly, the system may present pictures and links in many ways.

The following description provides specific details for a thorough understanding and an enabling description of these implementations. A skilled in the art will understand that the invention may be practiced without some details disclosed herein. Moreover, some well-known structures or functions will not be illustrated or described to their details to avoid unnecessarily obscuring the substantive features which are embodied in the relevant description of various implementations. Also, the terminology used throughout the whole description is intended to be interpreted in its broadest reasonable manner, though it may be used in conjunction with certain specific embodiments of the invention.

FIG. 6 and the following discussion provide a brief, general description of a suitable computing environment in which a system for loading partitioned data at a client end can be implemented. Although not required, aspects and implementations of the invention may be described in the general context of computer-executable instructions, such as routines executed by a general-purpose computer or a mobile device, e.g., a personal computer or smart phone. Those skilled in the art will appreciate that the invention can be practiced with other computer system configurations, including Internet appliances, set-top boxes, televisions, hand-held devices, wearable computers, vehicle computer systems, radios, household appliances (especially ones connected to the Internet), gaming consoles, mobile phones, laptops, netbooks, tablets, multiprocessor systems, microprocessor-based systems, minicomputers, mainframe computers, or the like. The invention can be embodied in a special purpose computer or data processor that is specifically programmed, configured, or constructed to perform one or more of the computer-executable instructions explained in detail below. Indeed, the terms “computer” or “computing system” as used generally herein, refer to devices that have a processor and non-transitory memory, like any of the above devices, as well as any data processor or any device capable of communicating with a network, including consumer electronic goods such as gaming devices, cameras, or other electronics having a data processor and other components, e.g., network communication circuitry. Data processors may include programmable general-purpose or special-purpose microprocessors, programmable controllers, application-specific integrated circuits (ASICs), programmable logic devices (PLDs), or the like, or a combination of such devices. Software may be stored in memory, such as random access memory (RAM), read-only memory (ROM), flash memory, or the like, or a combination of such components. Software may also be stored in one or more storage devices, such as magnetic or optical-based disks, flash memory devices, or any other type of non-volatile storage medium or non-transitory medium for data. Software may include one or more program modules, which include routines, programs, objects, components, data structures, and so on that perform particular tasks or implement particular abstract data types.

The invention can also be practiced in distributed computing environments, where tasks or modules are performed by remote processing devices, which are linked through a communications network, such as a Local Area Network (“LAN”), Wide Area Network (“WAN”), or the Internet. In a distributed computing environment, program modules or subroutines may be located in both local and remote memory storage devices. Aspects of the invention described below may be stored or distributed on tangible, non-transitory computer-readable media, including magnetic and optically readable and removable computer discs, stored in firmware in chips (e.g., EEPROM chips). Alternatively, aspects of the invention may be distributed electronically over the Internet or over other networks (including wireless networks). Those skilled in the art will recognize that portions of the invention may reside on a server computer, while corresponding portions reside on a client computer. Data structures and transmission of data particular to aspects of the invention are also encompassed within the scope of the invention.

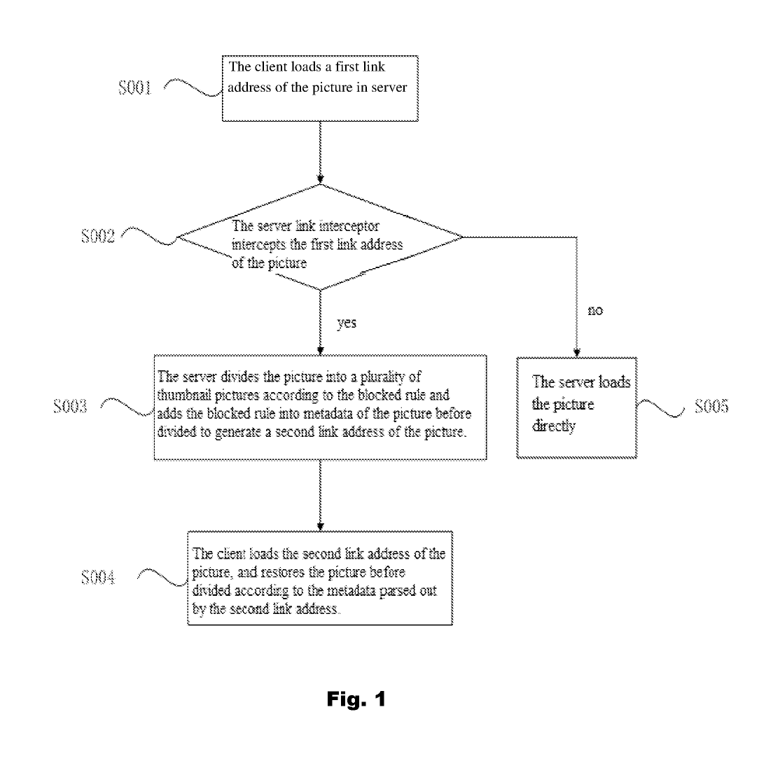

FIG. 1 schematically shows a process of loading a picture according to an embodiment of the present invention. The process can be performed at the computing system discussed above. Referring to FIG. 1, the process for loading the picture comprises:

Step S001: a first link address of a picture in server is loaded in a client end. The first link address is a uniform resource locator (URL) address of the picture generated by the processor of the server through coding a combination of the metadata of the picture comprising number of bytes, resolution, animation type, creation time, clipping coefficient and picture address, etc.

Step S002: a link interceptor, which may be software installed in the processor of the server, parses out metadata of the picture from the first link address of the picture, and checks whether the number of bytes of the picture exceeds a threshold set stored in a storage medium of the server according to the metadata of the picture.

Step S003: If it is determined that the number of bytes exceeds the threshold, then the processor divides the picture into a plurality of sub-pictures according to the partition rule and incorporates the partition rule into metadata of the original picture (i.e., before divided) to generate a second link address of the picture.

The partition rule may be determined based on an animation effect of displaying, resolution and other factors of a picture. Specifically, each divided sub-picture is numbered when dividing the picture, so that the loading can be done according to sequence of the numbering to render an animation effect.

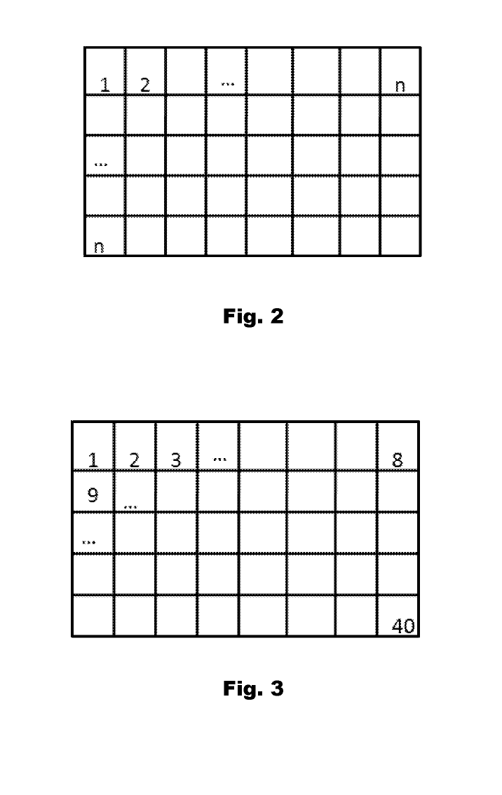

FIG. 2 schematically shows a partition rule for large pictures according to an embodiment of the present invention. Referring to FIG. 2, the picture is divided into a plurality of regions in a matrix form in accordance with the partition rule, clipping coefficient, and resolution of a picture, etc. For example, for a large picture with a resolution of 2N*2M, the picture is divided based on the value of the partition (i.e., clipping coefficient). For example, when the clipping coefficient is set to 2, the picture will be divided into (2N/2)*(2M/2) block regions. That is, the large picture is divided into regions with a width resolution of M and the height resolution of N to obtain N * M sub-pictures.

Step S004: the client end loads the second link address of the picture, and restores the original picture according to the metadata parsed out through the second link address.

Step S005: the processor of the server loads the picture directly when the number of bytes does not exceed the threshold set by the server.

To load the link address, the device side parses this address, gets information about the picture, such as size, resolution, clipping coefficient, animation type, etc., and then loads remotely the link via http protocol.

The above second link address is URL address of the picture intercepted by the link interceptor via nginx. .nginx (“engine x”) is a high performance http and reverse proxy server, and particularly an IMAP/POP3/SMTP proxy server. When the link interceptor intercepts the above second link address, it will perform a simple regulation match to determine whether the picture belongs to a partitioned large picture. Thus, a picture stream will be returned in a conventional way for a common picture, whilst for the partitioned large picture a play flow will be formed through combination of partitioned sub-pictures in an order of playing (in particular, a sequence of numbers assigned to each divided sub-pictures when dividing the picture) and sent to the client end.

“Restoring” is performed at the client end by first parsing the link address of the picture and then initiating an http request. Then, according to the set type of animation, the picture data returned from the server are received and the sub-pictures are loaded and displayed in the animation form consecutively to “restore” and present them to the user. As an example, the form of animation is to load the sub-pictures in a certain order.

FIG. 3 schematically shows a sequence of loading the partitioned pictures at the client end according to an embodiment of the present invention. Referring to FIG. 3, the original picture is divided into 8*5 sub-pictures. Loading of the picture is performed in an order according to the sequence of numbers as shown in FIG. 3. An order of restoring the picture at the client end is the same as the loading order, and the original picture is displayed in the animation form gradually. The above loading order is set according to the picture partition rule which is incorporated into the picture link address and will be parsed by the link interceptor at the client end from the link information.

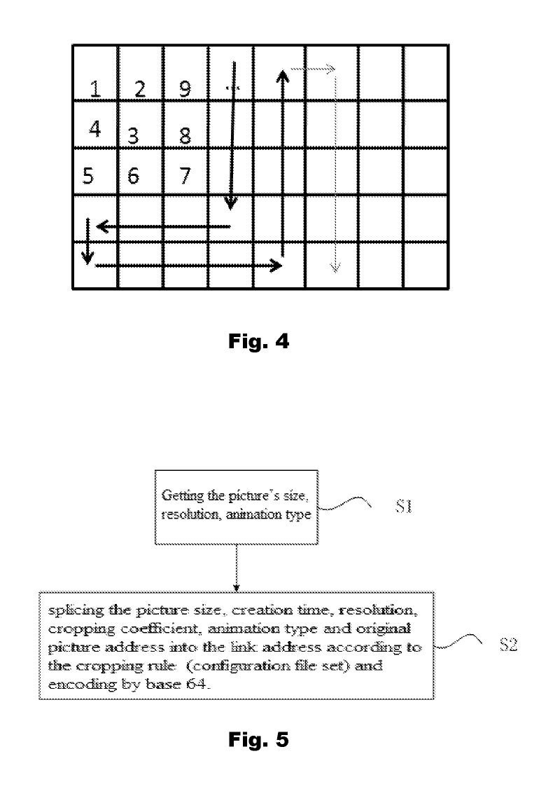

FIG. 4 schematically shows obtaining partitioned data and producing animation effect at a client end according to an embodiment of the present invention. The picture is divided into 8*5 sub-pictures or blocks. When dividing the picture, each of divided sub-pictures is numbered and the sub-pictures are loaded in a sequence of the numbering. The loading is done gradually to display the picture in the animation form. That is, the sub-pictures are loaded in a spiral form and in only one direction after the loading is completed in both vertical and horizontal directions. The animation form may be replaced with other forms such as louver, blinds, expanding, shrink, wedge, cut out, dissolve, fade, erasing, etc. according to different requirements.

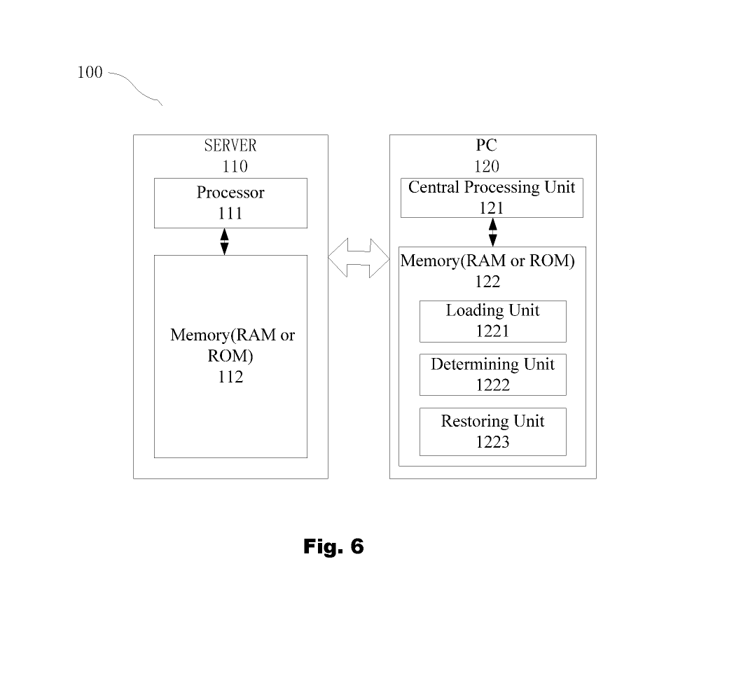

FIG. 5 schematically shows a generation of picture link addresses according to an embodiment of the present invention. As shown in FIG. 5, the process of generating link address comprises:

Step S1: Getting the picture's size, resolution, animation type and other picture parameters through a processor of a server.

The size and the resolution of a picture can be obtained using an open source picture processing software GraphicsMagick, e.g., by running the code: //gm identify verbose 1. jpg. Animation type can be obtained from the configuration file directly.

Step S2: Information on the picture, such as picture size, creation time, resolution, clipping coefficient, animation type and address of original picture are incorporated into a link address according to the partition rule made based on the size of picture bytes, picture resolution, and the type of animation. The link address is subject to a base64 encoding and is stored as a single picture link URL address. For example, a picture's original address is: group1/99999999-20141126114551123-1920*1080-02-a-aaaaaaaaaaaaaaa.jpg, wherein group1 refers to prefix which represents different types of pictures, “99999999” refers to the picture size (number of bytes), “20141126114551123” refers to creation time, “02” refers to the partition system, “a” refers to the type of animation, and “aaaaaaaaaaaaaaa” represents picture's address.

FIG. 6 schematically shows a system 100 for loading and displaying pictures according to an embodiment of the present invention. As shown in FIG. 6, the system 100 for loading and displaying pictures comprises a server 110 and a client end 120. The server 110 may comprise a processor 111 which executes software stored in memory 112 of the server 110 to check whether number of bytes of the picture exceeds a threshold stored in the memory 112 according to metadata of the picture parsed out by a first link address. If the number of bytes exceeds the threshold, then the picture is divided into a plurality of sub-pictures according to a partition rule which is incorporated into metadata of the original picture to generate a second link address of the picture.

The client end 120 may be a PC, a portable computer or other electronic device which generally comprises a central processing unit 121 and memory 122 and can execute software stored in its storage medium 122. The software comprises a loading unit 1221, a determining unit 1222 and a restoring unit 1223, all of which are stored in the memory 122 and are executed by the central processing unit 121 of the client end 120.

The loading unit 1221 is configured to load a first link address of the picture. The first link address may be a uniform resource locator (URL) address of the picture generated by coding a combination of metadata of the picture comprising number of bytes, resolution, animation type, creation time, clipping coefficient and picture address. The determining unit 1222 is configured to judge whether the number of bytes of the picture exceeds a threshold set by a loading means according to the metadata of the picture parsed out through the first link address of the picture. The restoring unit 1223 is configured to load the picture directly if the number of bytes does not exceed the threshold. On the other hand, if the number of bytes of the picture exceeds the threshold, and the picture has been divided into a plurality of sub-pictures according to a partition rule. The restoring unit 1223 functions to load a second link address of the picture which is generated by incorporating the partition rule into metadata of the original picture, and parses out the partition rule incorporated in the metadata of the picture by referring to the second link address, and then assembles data of the plurality of sub-pictures in accordance with the partition rule to restore the original picture.

It should be noted that, unless the context clearly requires otherwise, throughout the description and the claims, the words “comprise,” “comprising,” and the like are to be construed in an inclusive sense, as opposed to an exclusive or exhaustive sense. Additionally, the words “herein,” “above,” “below,” and words of similar import, when used in this application, refer to this application as a whole and not to any particular portions of this application. Where the context permits, words in the above description using the singular or plural number may also include the plural or singular number respectively. The word “or,” in reference to a list of two or more items, covers all of the following interpretations of the word: any of the items in the list, all of the items in the list, and any combination of the items in the list.

As noted above, particular terminology used when describing certain features or aspects of the invention should not be taken to imply that the terminology is being redefined herein to be restricted to any specific features, or aspects of the invention with which that terminology is associated. In general, the terms used in the following claims should not be construed to limit the invention to the specific examples disclosed in the specification, unless the above detailed description section explicitly defines such terms. Accordingly, the actual scope of the invention encompasses not only the disclosed examples, but also all equivalent ways of practicing or implementing the invention under the claims.

The above are only some embodiments of the present invention. One skilled in the art will readily appreciate that the devices, system and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer. Thus, various variations and modifications may be made without deviating from the scope of the embodiments, which fall within the protection scope of the present invention.

Certain aspects of the invention are presented below in certain claim forms, but the applicant contemplates the various aspects of the invention in any number of claim forms. Accordingly, the applicant reserves the right to pursue additional claims after filing this application to pursue such additional claim forms, in either this application or in a continuing application.

We claim:

1. A method of loading and displaying picture, wherein the method is performed by a computing system having a processor and a memory, the method comprising:
loading, at a server computer, a first link address of a picture to be uploaded;
determining, at the server computer, on whether a number of bytes of the picture exceeds a threshold according to metadata of the picture parsed from the first link address of the picture, and
dividing, at the server computer, the picture of which the number of bytes exceeds the threshold into a plurality of sub-pictures according to a partition rule, incorporating the partition rule into metadata of the original picture to generate a second link address of the picture, and
assembling, at a client end computer, picture data of the plurality of sub-pictures to restore the picture in accordance with the partition rule incorporated in the metadata which is parsed out by the processor of the client end loading the second link address.

2. The method of claim 1, wherein the first link address is a URL address of the picture generated by a combining coding of the metadata of the picture comprising at least one of number of bytes, resolution, animation type, creation time, clipping coefficient and picture address.

3. The method of claim 1, wherein the partition rule comprises dividing the picture into a plurality of regions in a matrix form based on animation effect and/or resolution of the picture.

4. The method of claim 1, wherein the loading and displaying is conducted gradually in an animation form by the client-end computer.

5. The method of claim 4, wherein a sequence of loading in the animation form is to number each divided sub-picture when dividing the picture by the processor of the server computer, and then load the picture according to the sequence of the numbering.

6. The method of claim 5, wherein the animation form is selected from the following groups: spiral, louver, blinds, expanding, shrink, wedging, cut out, dissolve, fade, and erasing.

7. A device for loading and displaying pictures, wherein the device includes a processor and a memory, comprising:
a loading means implemented by a processor and configured to load a first link address of a picture;
a determining means implemented by a processor and configured to judge whether a number of bytes of the picture exceeds a threshold set by the loading means according to metadata of the picture parsed out by the first link address of the picture; and
a restoring means implemented by a processor and configured to load a second link address of the picture which has been divided into a plurality of sub-pictures according to a partition rule if the number of bytes of the picture exceeds the threshold, parse out a partition rule incorporated in the metadata through the second link address, and assemble data of the plurality of sub-pictures in accordance with the partition rule to restore the picture.

8. The device of claim 7, wherein the first link address is a URL address of the picture generated by coding of a combination of the metadata of the picture comprising at least one of number of bytes, resolution, animation type, creation time, clipping coefficient and picture address.

9. A system for loading and displaying pictures, comprising.
a server, comprising a processor and a memory, the processor executes instructions stored in the memory to
judge whether a number of bytes of a picture exceeds a threshold set by the server according to metadata of the picture parsed out according to a first link address, and
divide the picture into a plurality of sub-pictures according to a partition rule, if the number of bytes exceeds the threshold set by the server, and then add the partition rule into the metadata of the original picture to generate a second link address of the picture;
a client end having a processor and a memory, the processor executes instructions stored in the memory to
load the first link address of the picture directly and display the picture when it is judged that the number of bytes of the picture does not exceed the threshold, and
load the second link address, if it is judged that the number of bytes of the picture exceeds the threshold, and restore and display the original picture based on the metadata parsed out through the second link address.

10. The system of claim 9, wherein the first link address is a URL address of the picture generated by a combining coding of the metadata of the picture comprising at least one of number of bytes, resolution, animation type, creation time, clipping coefficient and picture address.

11. A computer-readable storage device carrying instructions for performing a method of loading and displaying picture, comprising:
loading a first link address of a picture to be uploaded;
determining on whether a number of bytes of the picture exceeds a threshold according to metadata of the picture parsed from the first link address of the picture,
dividing the picture of which the number of bytes exceeds the threshold into a plurality of sub-pictures according to a partition rule, incorporating the partition rule into metadata of the original picture to generate a second link address of the picture, and
assembling picture data of the plurality of sub-pictures to restore the picture in accordance with the partition rule incorporated in the metadata which is parsed out by the processor of the client end loading the second link address.

12. The computer-readable storage device of claim 11, wherein the first link address is a URL address of the picture generated by a combining coding of the metadata of the picture comprising at least one of number of bytes, resolution, animation type, creation time, clipping coefficient and picture address.

13. The computer-readable storage device of claim 11, wherein the partition rule comprises dividing the picture into a plurality of regions in a matrix form based on animation effect and/or resolution of the picture.

14. The computer-readable storage device of claim 11, wherein the loading and displaying is conducted gradually in an animation form.

15. The computer-readable storage device of claim 14, wherein a sequence of loading in the animation form is to number each divided sub-picture when dividing the picture by the processor of the server computer, and then load the picture according to the sequence of the numbering.

16. The computer-readable storage device of claim 15, wherein the animation form is selected from the following groups: spiral, louver, blinds, expanding, shrink, wedging, cut out, dissolve, fade, and erasing.
